(19) United States
(12) Patent Application Publication
(10) Pub. No.: US 2025/0210826 A1
(43) Pub. Date: Jun. 26, 2025

(54) BATTERY

(71) Applicant: MURATA MANUFACTURING CO., LTD., Kyoto (JP)

(72) Inventors: Aya MASHIKO, Kyoto (JP); Koya YANO, Kyoto (JP); Tsuyoshi YAMAMOTO, Kyoto (JP); Masahiro OTSUKA, Kyoto (JP)

(21) Appl. No.: 19/080,286

(22) Filed: Mar. 14, 2025

Related U.S. Application Data
(63) Continuation of application No. PCT/JP2023/037465, filed on Oct. 17, 2023.

(30) Foreign Application Priority Data
Dec. 1, 2022 (JP) 2022-193112

(51) Int. Cl. H01M 50/533; H01M 50/109; H01M 50/153; H01M 50/181; H01M 50/188; H01M 50/528

(52) U.S. Cl. CPC H01M 50/533; H01M 50/109; H01M 50/153; H01M 50/181; H01M 50/188; H01M 50/528

(57) ABSTRACT

A battery is provided and includes a battery device, an outer package member, an external terminal, a first electrode lead, and a second electrode lead. The battery device includes a first electrode and a second electrode. The outer package member contains the battery device. The external terminal is attached to the outer package member with an insulating member interposed between the external terminal and the outer package member. The first electrode lead couples the first electrode and an inner surface of the external terminal to each other. The second electrode lead couples the second electrode and an inner surface of the outer package member to each other. One or each of the first electrode lead and the second electrode lead includes a first end part, a middle part, and a second end part in order along a width direction orthogonal to a longitudinal direction of corresponding one of the first electrode lead or the second electrode lead. The middle part is flat and is welded to the inner surface of the external terminal or the inner surface of the outer package member. The first end part, the second end part, or both are bent in a direction away from the inner surface of the external terminal or the inner surface of the outer package member.

### CROSS REFERENCE TO RELATED APPLICATIONS

The present application is a continuation of International Patent Application No. PCT/JP2023/037465, filed on Oct. 17, 2023, which claims priority to Japanese Patent Application No. 2022-193112, filed on Dec. 1, 2022, the entire contents of which are incorporated herein by reference.

### BACKGROUND

The present disclosure relates to a battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolyte that are contained inside an outer package member. A configuration of the secondary battery has been considered in various ways.

For example, a sealed electrical storage device is disclosed including an electrode body and an outer package casing. The electrode body includes a positive electrode body and a negative electrode body that are stacked or wound with a separator interposed therebetween. The outer package casing contains the electrode body.

### SUMMARY

The present disclosure relates to a battery.

Consideration has been given in various ways to improve performance of a secondary battery. However, there is room for improvement in terms of the performance of the secondary battery.

It is therefore desirable to provide a battery having higher reliability.

A battery according to an embodiment of the present disclosure includes a battery device, an outer package member, an external terminal, a first electrode lead, and a second electrode lead. The battery device includes a first electrode and a second electrode. The outer package member contains the battery device. The external terminal is attached to the outer package member with an insulating member interposed between the external terminal and the outer package member. The first electrode lead couples the first electrode and an inner surface of the external terminal to each other. The second electrode lead couples the second electrode and an inner surface of the outer package member to each other. One or each of the first electrode lead and the second electrode lead includes a first end part, a middle part, and a second end part in order along a width direction orthogonal to a longitudinal direction of corresponding one of the first electrode lead or the second electrode lead. The middle part is flat and is welded to the inner surface of the external terminal or the inner surface of the outer package member. The first end part, the second end part, or both are bent in a direction away from the inner surface of the external terminal or the inner surface of the outer package member.

According to the battery of an embodiment of the present disclosure, the first end part, the second end part, or both the first and the second end parts of one or each of the first electrode lead and the second electrode lead are bent in the direction away from the inner surface of the external terminal or the inner surface of the outer package member. The battery according to an embodiment of the present disclosure thus has higher reliability.

Note that effects of the present disclosure are not necessarily limited to those described herein and may include any of a series of effects described below in relation to the present technology.

### BRIEF DESCRIPTION OF THE FIGURES

FIG. 1 is a perspective diagram illustrating a configuration of a secondary battery according to an embodiment of the present disclosure.

FIG. 2 is a sectional diagram illustrating the configuration of the secondary battery illustrated in FIG. 1.

FIG. 3 is a partial sectional diagram illustrating a configuration of a battery device illustrated in FIG. 2.

FIG. 4A is a plan diagram illustrating a configuration of a positive electrode lead illustrated in FIG. 2.

FIG. 4B is a first sectional diagram illustrating the configuration of the positive electrode lead illustrated in FIG. 2.

FIG. 4C is a second sectional diagram illustrating the configuration of the positive electrode lead illustrated in FIG. 2.

FIG. 5A is a plan diagram illustrating a configuration of a negative electrode lead illustrated in FIG. 2.

FIG. 5B is a first sectional diagram illustrating the configuration of the negative electrode lead illustrated in FIG. 2.

FIG. 5C is a second sectional diagram illustrating the configuration of the negative electrode lead illustrated in FIG. 2.

FIG. 6 is a perspective diagram illustrating a configuration of an outer package can to be used in a manufacturing process of the secondary battery illustrated in FIG. 1.

### DETAILED DESCRIPTION

One or more embodiments of the present disclosure are described below in further detail including with reference to the drawings.

A description is given first of a secondary battery according to an embodiment of the present disclosure.

The secondary battery to be described here has a flat and columnar three-dimensional shape, and is commonly referred to as, for example, a coin type or a button type. As will be described later, the secondary battery includes two bottom parts opposed to each other, and a sidewall part positioned between the two bottom parts. The secondary battery has a height smaller than an outer diameter. Herein, the “outer diameter” refers to a maximum diameter (a maximum outer diameter) of the bottom parts. In the secondary battery, the two bottom parts opposed to each other have respective maximum diameters that are substantially equal to each other. Herein, the “height” refers to a maximum distance from an upper surface of one of the bottom parts to a lower surface of the other of the bottom parts. Note that in the present embodiment, a direction in which the two bottom parts are opposed to each other corresponds to a height direction Z.

Although a charge and discharge principle of the secondary battery is not particularly limited, the following description deals with a case where a battery capacity is obtained using insertion and extraction of an electrode reactant. The secondary battery includes a positive electrode, a negative electrode, and an electrolyte. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is set to be greater than an electrochemical capacity per unit area of the positive electrode. Note that the secondary battery according to the present embodiment is a high-charge-voltage secondary battery that is configured to achieve a favorable cyclability characteristic with no decrease in energy density, even if the secondary battery is charged with a high voltage of 4.38 V or higher.

Although not particularly limited in kind, the electrode reactant is specifically a light metal such as an alkali metal or an alkaline earth metal. Examples of the alkali metal include lithium, sodium, and potassium. Examples of the alkaline earth metal include beryllium, magnesium, and calcium.

Examples are given below of a case in which the electrode reactant is lithium. A secondary battery in which a battery capacity is obtained through insertion and extraction of lithium is what is called a lithium-ion secondary battery. In the lithium-ion secondary battery, lithium is inserted and extracted in an ionic state.

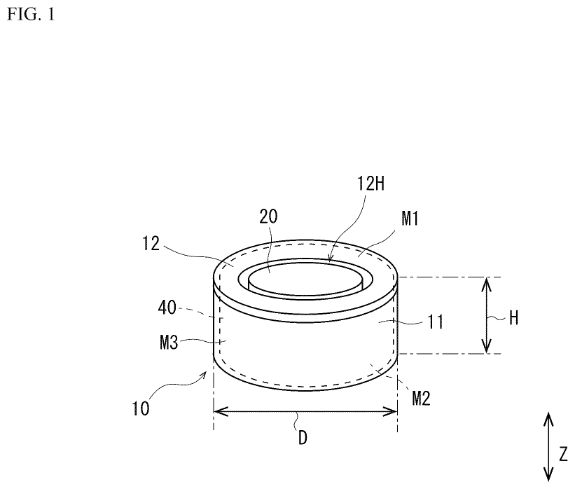

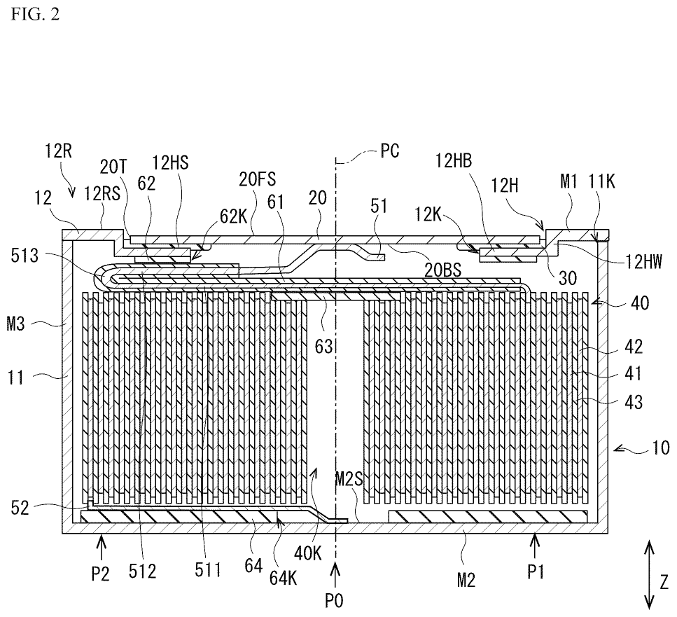

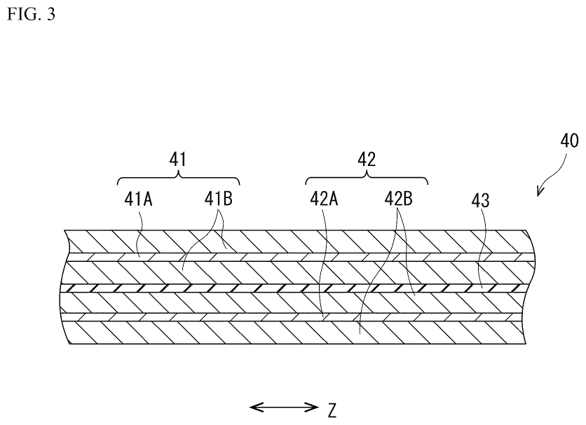

FIG. 1 illustrates a perspective configuration of the secondary battery. FIG. 2 illustrates a sectional configuration of the secondary battery illustrated in FIG. 1. FIG. 3 illustrates a sectional configuration of a battery device 40 illustrated in FIG. 2. Note that FIG. 3 illustrates only a portion of the sectional configuration of the battery device 40 in an enlarged manner.

For convenience, the following description is given with an upper side of each of FIGS. 1 and 2 assumed to be an upper side of the secondary battery, and a lower side of each of FIGS. 1 and 2 assumed to be a lower side of the secondary battery.

The secondary battery to be described here has a three-dimensional shape in which a height H is smaller than an outer diameter D, as illustrated in FIG. 1. In other words, the secondary battery has a flat and columnar three-dimensional shape. Here, the three-dimensional shape of the secondary battery is flat and cylindrical (circular columnar). Note that, in the present embodiment, an up-down direction in a sheet plane in each of FIGS. 1 and 2 is assumed to be the height direction Z. Accordingly, the height H means a dimension, of the secondary battery of the present embodiment, in the height direction Z. The outer diameter D means a dimension, of the secondary battery of the present embodiment, in a direction orthogonal to the height direction Z.

Dimensions of the secondary battery are not particularly limited. However, for example, the outer diameter D is within a range from 3 mm to 30 mm both inclusive, and the height H is within a range from 0.5 mm to 70 mm both inclusive. Note that a ratio of the outer diameter D to the height H, i.e., D/H, is greater than 1. In other words, the outer diameter D is greater than the height H. Although not particularly limited, an upper limit of the ratio (D/H) is preferably 25 or less.

As illustrated in FIGS. 1 to 3, the secondary battery includes an outer package can 10, an external terminal 20, the battery device 40, and a positive electrode lead 51. Here, the secondary battery further includes a gasket 30, a negative electrode lead 52, a sealant 61, and insulating films 62 and 63.

As illustrated in FIGS. 1 and 2, the outer package can 10 is a hollow outer package member to contain the battery device 40 and other components. The outer package can 10 includes an electrically conductive material.

Here, the outer package can 10 has a flat and substantially circular columnar three-dimensional shape corresponding to the three-dimensional shape of the secondary battery that is flat and circular columnar. Accordingly, the outer package can 10 includes two bottom parts M1 and M2 opposed to each other, and a sidewall part M3 positioned between the bottom parts M1 and M2. That is, the sidewall part M3 couples the bottom part M1 and the bottom part M2 to each other, and surrounds the battery device 40. The sidewall part M3 has an upper end part coupled to the bottom part M1, and a lower end part coupled to the bottom part M2. As described above, the outer package can 10 is substantially circular columnar. The bottom parts M1 and M2 are each circular in plan shape, and a surface of the sidewall part M3 is a convexly curved surface.

The outer package can 10 includes a container part 11 and a cover part 12 that are welded to each other. That is, an internal space of the outer package can 10 is sealed by the cover part 12 being welded to the container part 11. Note that in the present embodiment, the bottom part M1 forms the cover part 12, and the bottom part M2 and the sidewall part M3 together form the container part 11. Accordingly, an outer edge of the cover part 12 is welded to the upper end part of the sidewall part M3.

The container part 11 is a container member that is to contain the battery device 40 and other components inside, and has a flat and circular columnar shape. The container part 11 has a hollow structure with an upper end part open and a lower end part closed. That is, the container part 11 has an opening 11K (FIG. 2) at the upper end part. The opening 11K serves as a passing-through hole through which the battery device 40 is passable in the height direction Z.

The cover part 12 is a substantially disk-shaped cover member that closes the opening 11K of the container part 11, and has a through hole 12K. The through hole 12K is used as a coupling path for coupling the battery device 40 and the external terminal 20 to each other. The cover part 12 is welded to the container part 11 at the opening 11K, as described above. The external terminal 20 is attached to the cover part 12 with the gasket 30 interposed therebetween. That is, the cover part 12 supports the external terminal 20 with the gasket 30 interposed therebetween. The external terminal 20 is so attached to the cover part 12, with the gasket 30 interposed therebetween, as to overlap the through hole 12K and to close the through hole 12K. The external terminal 20 is electrically insulated from the outer package can 10.

In the secondary battery having been completed, the cover part 12 is in a state of having been welded to the container part 11 as described above. The opening 11K has been closed by the cover part 12 as described above. It may thus seem that whether the container part 11 has had the opening 11K is no longer recognizable from an external appearance of the secondary battery.

However, if the cover part 12 is welded to the container part 11, welding marks remain on a surface of the outer package can 10, more specifically, at a boundary part between the container part 11 and the cover part 12. Whether the container part 11 has had the opening 11K is recognizable afterward by checking the presence or absence of the welding marks.

Specifically, the welding marks remaining on the surface of the outer package can 10 indicates that the container part 11 has had the opening 11K. In contrast, no welding marks remaining on the surface of the outer package can 10 indicates that the container part 11 has had no opening 11K.

The cover part 12 is so bent as to partly protrude along the height direction Z toward an inside of the container part 11 and thus includes a recessed part 12H. Specifically, as viewed from outside the outer package can 10, the cover part 12 has a shape that is partly recessed in the height direction Z toward the battery device 40 contained inside the outer package can 10. The recessed part 12H has the through hole 12K provided through the cover part 12 in the height direction Z, a bottom part 12HB surrounding the through hole 12K along a horizontal plane orthogonal to the height direction Z, and a wall part 12HW provided upright along an outer edge of the bottom part 12HB.

A portion of the cover part 12 other than the recessed part 12H is a peripheral part 12R. The peripheral part 12R is provided to surround the recessed part 12H and has an annular shape in the horizontal plane orthogonal to the height direction Z of the secondary battery. The peripheral part 12R is a portion that surrounds a periphery of the recessed part 12H and protrudes away from the battery device 40 along the height direction Z. Accordingly, a surface 12HS of the bottom part 12HB of the recessed part 12H is at a low position in the height direction Z toward the inside of the container part 11 as compared with a surface 12RS of the peripheral part 12R. In other words, a distance from the surface 12HS of the bottom part 12HB of the recessed part 12H to the battery device 40 in the height direction Z is shorter than a distance from the surface 12RS of the peripheral part 12R to the battery device 40 in the height direction Z.

A shape of the recessed part 12H in a plan view, that is, a shape defined by an outer edge of the recessed part 12H when the secondary battery is viewed from above, is not particularly limited. Here, the recessed part 12H has a substantially circular shape in a plan view. Note that an inner diameter and a depth of the recessed part 12H are each not particularly limited and may be set as desired. However, the depth of the recessed part 12H is so set as to allow a height position of a surface 20FS of the external terminal 20 to be lower than a height position of the surface 12RS of the peripheral part 12R, in a state where the external terminal 20 is attached to the recessed part 12H with the gasket 30 interposed therebetween.

As described above, the outer package can 10 is what is called a welded can in which the container part 11 and the cover part 12 that have been physically separate from each other are welded to each other. Thus, the outer package can 10 after the welding is a single member that is physically integral as a whole, and is therefore in a state of being not separable into the container part 11 and the cover part 12 afterward.

The outer package can 10 that is a welded can is different from a crimped can formed by crimping processing, and is what is called a crimpless can. One reason for this is to increase a device space volume inside the outer package can 10 and to thereby increase an energy density per unit volume. The “device space volume” refers to a volume (an effective volume) of the internal space of the outer package can 10 available for containing the battery device 40.

Further, the outer package can 10 that is the welded can does not include any portion folded over another portion, and does not include any portion in which two or more members lie over each other.

The wording “does not include any portion folded over another portion” means that the outer package can 10 is not so processed (subjected to bending processing) as to include a portion folded over another portion. The wording “does not include any portion in which two or more members lie over each other” means that the outer package can 10 after completion of the secondary battery is physically a single member and is thus not separable into two or more members afterward. That is, the outer package can 10 in the secondary battery having been completed is not in a state where two or more members lie over each other and are so combined with each other as to be separable from each other afterward.

Here, the outer package can 10 is electrically conductive. To be more specific, the container part 11 and the cover part 12 are each electrically conductive. The outer package can 10 is electrically coupled to a negative electrode 42 of the battery device 40 via the negative electrode lead 52. Accordingly, the outer package can 10 also serves as an external coupling terminal of the negative electrode 42. The secondary battery of the present embodiment does not require the external coupling terminal of the negative electrode 42 separate from the outer package can 10, and thus suppresses a decrease in device space volume resulting from providing the external coupling terminal of the negative electrode 42. As a result, the device space volume increases, and the energy density per unit volume increases accordingly.

Specifically, the outer package can 10 is a metal can that includes any one or more of electrically conductive materials including, without limitation, a metal material and an alloy material. Examples of the electrically conductive material included in the metal can include iron, copper, nickel, stainless steel, an iron alloy, a copper alloy, and a nickel alloy. The stainless steel is not particularly limited in kind, and specific examples thereof include SUS304 and SUS316. Note that the container part 11 and the cover part 12 may include respective materials that are the same as or different from each other.

The cover part 12 is insulated, via the gasket 30, from the external terminal 20 serving as an external coupling terminal of a positive electrode 41. One reason for this is to prevent contact, or a short circuit, between the outer package can 10 that is the external coupling terminal of the negative electrode 42 and the external terminal 20 that is the external coupling terminal of the positive electrode 41.

As illustrated in FIGS. 1 and 2, the external terminal 20 is a coupling terminal to be coupled to electronic equipment when the secondary battery is mounted on the electronic equipment. As described above, the external terminal 20 is attached to the cover part 12 of the outer package can 10 to be supported by the cover part 12. The external terminal 20 is provided at a position that is on an opposite side of the cover part 12 to the bottom part M2 and at which the external terminal 20 overlaps the through hole 12K in the height direction Z.

Here, the external terminal 20 is coupled to the positive electrode 41 of the battery device 40 via the positive electrode lead 51. The external terminal 20 thus serves as the external coupling terminal of the positive electrode 41. Accordingly, upon use of the secondary battery, the secondary battery is coupled to electronic equipment via the external terminal 20 serving as the external coupling terminal of the positive electrode 41 and the outer package can 10 serving as the external coupling terminal of the negative electrode 42. This allows the electronic equipment to operate by using the secondary battery as a power source.

The external terminal 20 is a flat and substantially plate-shaped member that spreads along a horizontal plane orthogonal to the height direction Z of the secondary battery, and is disposed inside the recessed part 12H with the gasket 30 interposed between the external terminal 20 and the recessed part 12H. The external terminal 20 is insulated from the cover part 12 via the gasket 30. Here, as illustrated in FIG. 2, a position of a front surface 20FS of the external terminal 20 is low in the height direction Z toward the battery device 40 as compared with a position of the surface 12RS of the peripheral part 12R of the outer package can 10. In other words, the external terminal 20 is contained inside the recessed part 12H in such a manner that the front surface 20FS, which is an upper end of the external terminal 20, is recessed toward the battery device 40 as compared with the surface 12RS. In the secondary battery of the present embodiment, the height of the secondary battery is reduced as compared with when the external terminal 20 protrudes above the cover part 12. This increases the energy density per unit volume of the secondary battery. This also makes it possible to prevent a short circuit between the outer package can 10 and the external terminal 20 from being caused by another electrically conductive member. Further, in the present embodiment, a peripheral portion of the external terminal 20 overlaps the bottom part 12HB of the recessed part 12H in the height direction Z. Owing to the external terminal 20 and the cover part 12 having such an overlap portion, it is possible to improve mechanical strength of the secondary battery as a whole. Here, a length, of the overlap portion of the external terminal 20 and the peripheral portion, along a horizontal plane orthogonal to the height direction Z is preferably greater than a thickness of the external terminal 20 and greater than a thickness of the bottom part 12HB.

Note that the external terminal 20 has an outer diameter smaller than the inner diameter of the recessed part 12H. An outer edge 20T of the external terminal 20 is thus spaced from the cover part 12. The gasket 30 is disposed in only a portion of a region between the external terminal 20 and the cover part 12 (the recessed part 12H). More specifically, the gasket 30 is disposed only at a location where the external terminal 20 and the cover part 12 would be in contact with each other if it were not for the gasket 30. However, the gasket 30 is preferably also provided between an inner wall face of the wall part 12HW of the recessed part 12H and the outer edge 20T of the external terminal 20. Further, the cover part 12 and the external terminal 20 are preferably stuck to each other by the gasket 30.

Further, the external terminal 20 includes any one or more of electrically conductive materials including, without limitation, a metal material and an alloy material. Examples of the electrically conductive materials include aluminum and an aluminum alloy. However, the external terminal 20 may include a cladding material. The cladding material includes an aluminum layer and a nickel layer disposed in order from a side closer to the gasket 30. In the cladding material, the aluminum layer and the nickel layer are roll-bonded to each other.

The gasket 30 is an insulating member disposed between the outer package can 10 (the cover part 12) and the external terminal 20, as illustrated in FIG. 2. The external terminal 20 is fixed to the cover part 12 with the gasket 30 interposed therebetween. The gasket 30 is ring-shaped in a plan view and has a through hole at a location corresponding to the through hole 12K. The gasket 30 includes any one or more of insulating materials including, without limitation, a polymer compound having an insulating property. Examples of the insulating materials include a resin such as polypropylene or polyethylene.

A range of placement of the gasket 30 is not particularly limited, and may be chosen as desired. Here, the gasket 30 is disposed in a gap between an upper surface of the cover part 12 and a lower surface of the external terminal 20, inside the recessed part 12H. However, as described above, the gasket 30 is preferably also provided between the inner wall face of the wall part 12HW of the recessed part 12H and the outer edge 20T of the external terminal 20. Further, the cover part 12 and the external terminal 20 are preferably stuck to each other by the gasket 30.

The battery device 40 is a power generation device that causes charging and discharging reactions to proceed. As illustrated in FIGS. 2 and 3, the battery device 40 is contained inside the outer package can 10. The battery device 40 includes the positive electrode 41 and the negative electrode 42. Here, the battery device 40 further includes a separator 43 and an electrolytic solution. The electrolytic solution is a liquid electrolyte, and is not illustrated.

A center line PC illustrated in FIG. 2 is a line segment corresponding to a center of the battery device 40 in a direction along the outer diameter D of the secondary battery (the outer package can 10). More specifically, a position P0 of the center line PC corresponds to a position of the center of the battery device 40.

The battery device 40 is what is called a wound electrode body. More specifically, in the battery device 40, the positive electrode 41 and the negative electrode 42 are stacked on each other with the separator 43 interposed therebetween. In addition, the stack of the positive electrode 41, the negative electrode 42, and the separator 43 is wound around the center line PC as a winding axis, as illustrated in FIG. 2. The positive electrode 41 and the negative electrode 42 are wound, remaining in a state of being opposed to each other with the separator 43 interposed therebetween. As a result, a winding center space 40K is present at the center of the battery device 40.

Here, the positive electrode 41, the negative electrode 42, and the separator 43 are so wound that the separator 43 is disposed in each of an outermost wind of the wound electrode body and an innermost wind of the wound electrode body. Respective numbers of winds of the positive electrode 41, the negative electrode 42, and the separator 43 are not particularly limited, and may be chosen as desired. In addition, the negative electrode 42 is positioned on an outer side relative to the positive electrode 41, in an outermost wind of the battery device 40. In other words, an outermost positive electrode wind part positioned in an outermost wind of the positive electrode 41 included in the battery device 40 is positioned on an inner side relative to an outermost negative electrode wind part positioned in an outermost wind of the negative electrode 42 included in the battery device 40. Here, the outermost positive electrode wind part is a part corresponding to the outermost one wind of the positive electrode 41 in the battery device 40. The outermost negative electrode wind part is a part corresponding to the outermost one wind of the negative electrode 42 in the battery device 40. In contrast, in an innermost wind of the battery device 40, the negative electrode 42 is preferably positioned on the inner side relative to the positive electrode 41. In other words, an innermost negative electrode wind part that is positioned in an innermost wind of the negative electrode 42 included in the battery device 40 is preferably positioned on the inner side relative to an innermost positive electrode wind part that is positioned in an innermost wind of the positive electrode 41 included in the battery device 40. Here, the innermost positive electrode wind part is a part corresponding to the innermost one wind of the positive electrode 41 in the battery device 40. The innermost negative electrode wind part is a part corresponding to the innermost one wind of the negative electrode 42 in the battery device 40.

The battery device 40 has a three-dimensional shape similar to the three-dimensional shape of the outer package can 10. Specifically, the battery device 40 has a flat and substantially circular columnar three-dimensional shape. This helps to prevent what is called a dead space, more specifically, a gap between the outer package can 10 and the battery device 40, from easily resulting when the battery device 40 is placed inside the outer package can 10, as compared with when the battery device 40 has a three-dimensional shape different from the three-dimensional shape of the outer package can 10. This allows for efficient use of the internal space of the outer package can 10. As a result, the device space volume increases, and the energy density per unit volume of the secondary battery increases accordingly.

The positive electrode 41 is a first electrode to be used to cause the charging and discharging reactions to proceed. As illustrated in FIG. 3, the positive electrode 41 includes a positive electrode current collector 41A and a positive electrode active material layer 41B.

The positive electrode current collector 41A has two opposed surfaces on each of which the positive electrode active material layer 41B is to be provided. The positive electrode current collector 41A includes an electrically conductive material such as a metal material. Examples of the metal material include aluminum.

The positive electrode active material layer 41B is provided on each of the two opposed surfaces of the positive electrode current collector 41A. The positive electrode active material layer 41B includes any one or more of positive electrode active materials into which lithium is insertable and from which lithium is extractable. Note that the positive electrode active material layer 41B may be provided only on one of the two opposed surfaces of the positive electrode current collector 41A. The positive electrode active material layer 41B may further include other materials including, without limitation, a positive electrode binder and a positive electrode conductor. A method of forming the positive electrode active material layer 41B is not particularly limited, and specific examples thereof include a coating method.

The positive electrode active material includes a lithium compound. The term “lithium compound” is a generic term for a compound that includes lithium as a constituent element. More specifically, the lithium compound is a compound that includes lithium and one or more transition metal elements as constituent elements. One reason for this is that a high energy density is obtainable. Note that the lithium compound may further include any one or more of other elements (excluding lithium and transition metal elements). Although not particularly limited in kind, the lithium compound is specifically an oxide, a phosphoric acid compound, a silicic acid compound, or a boric acid compound, for example. Specific examples of the oxide include LiNiO₂, LiCoO₂, and LiMn₂O₄. Specific examples of the phosphoric acid compound include LiFePO₄ and LiMnPO₄.

The positive electrode binder includes any one or more of materials including, without limitation, a synthetic rubber and a polymer compound. Examples of the synthetic rubber include a styrene-butadiene-based rubber. Examples of the polymer compound include polyvinylidene difluoride. The positive electrode conductor includes any one or more of electrically conductive materials including, without limitation, a carbon material. Examples of the carbon material include graphite, carbon black, acetylene black, and Ketjen black. The electrically conductive material may be a metal material or a polymer compound, for example.

The negative electrode 42 is a second electrode to be used to cause the charging and discharging reactions to proceed. As illustrated in FIG. 3, the negative electrode 42 includes a negative electrode current collector 42A and a negative electrode active material layer 42B.

The negative electrode current collector 42A has two opposed surfaces on each of which the negative electrode active material layer 42B is to be provided. The negative electrode current collector 42A includes an electrically conductive material such as a metal material. Examples of the metal material include copper.

The negative electrode active material layer 42B is provided on each of the two opposed surfaces of the negative electrode current collector 42A. The negative electrode active material layer 42B includes any one or more of negative electrode active materials into which lithium is insertable and from which lithium is extractable. Note that the negative electrode active material layer 42B may be provided only on one of the two opposed surfaces of the negative electrode current collector 42A. The negative electrode active material layer 42B may further include other materials including, without limitation, a negative electrode binder and a negative electrode conductor. Details of the negative electrode binder are similar to the details of the positive electrode binder. Details of the negative electrode conductor are similar to the details of the positive electrode conductor. A method of forming the negative electrode active material layer 42B is not particularly limited, and specifically includes any one or more of methods including, without limitation, a coating method, a vapor-phase method, a liquid-phase method, a thermal spraying method, and a firing (sintering) method.

The negative electrode active material includes a carbon material, a metal-based material, or both. One reason for this is that a high energy density is obtainable. Examples of the carbon material include graphitizable carbon, non-graphitizable carbon, and graphite (natural graphite and artificial graphite). The metal-based material is a material that includes, as one or more constituent elements, any one or more elements among metal elements and metalloid elements that are each able to form an alloy with lithium. Examples of such metal elements and metalloid elements include silicon, tin, or both. The metal-based material may be a simple substance, an alloy, a compound, a mixture of two or more thereof, or a material including two or more phases thereof. Specific examples of the metal-based material include TiSi₂ and SiOₓ (0<x≤2 or 0.2<x<1.4).

Here, the negative electrode 42 has a height greater than a height of the positive electrode 41. More specifically, the negative electrode 42 protrudes above the positive electrode 41, and protrudes below the positive electrode 41. One reason for this is to prevent precipitation of lithium extracted from the positive electrode 41. The “height” is a dimension corresponding to the height H of the secondary battery described above, that is, a dimension in the up-down direction in each of FIGS. 1 and 2. The definition of the height described here applies also to the following.

The separator 43 is an insulating porous film disposed between the positive electrode 41 and the negative electrode 42, as illustrated in FIGS. 2 and 3. The separator 43 allows lithium ions to pass through the separator 43 and prevents a short circuit between the positive electrode 41 and the negative electrode 42. The separator 43 includes a polymer compound such as polyethylene.

Here, the separator 43 has a height greater than the height of the negative electrode 42, as illustrated in FIG. 2. More specifically, the separator 43 preferably protrudes above the negative electrode 42 and protrudes below the negative electrode 42.

The electrolytic solution includes a solvent and an electrolyte salt. The positive electrode 41, the negative electrode 42, and the separator 43 are each impregnated with the electrolytic solution. The solvent includes any one or more of non-aqueous solvents (organic solvents) including, without limitation, a carbonic-acid-ester-based compound, a carboxylic-acid-ester-based compound, and a lactone-based compound. An electrolytic solution that includes any of the non-aqueous solvents is what is called a non-aqueous electrolytic solution. The electrolyte salt includes any one or more of light metal salts including, without limitation, a lithium salt.

As illustrated in FIG. 2, the positive electrode lead 51 is contained inside the outer package can 10. The positive electrode lead 51 is a coupling wiring coupled to each of the positive electrode 41 and the external terminal 20. The secondary battery illustrated in FIG. 2 includes one positive electrode lead 51. However, the secondary battery may include two or more positive electrode leads 51.

The positive electrode lead 51 is coupled to an upper end part of the positive electrode 41. Specifically, the positive electrode lead 51 is coupled to an upper end part of the positive electrode current collector 41A. Further, the positive electrode lead 51 is coupled to a portion of the back surface 20BS of the external terminal 20 through the through hole 12K provided in the cover part 12. A method of coupling the positive electrode lead 51 is not particularly limited, and specifically includes any one or more of welding methods including, without limitation, a resistance welding method and a laser welding method. The details of the welding methods described here apply also to the following.

A portion of the positive electrode lead 51 is electrically insulated from each of the cover part 12 of the outer package can 10 and the negative electrode 42 of the battery device 40, and is sandwiched by the cover part 12 and the battery device 40 in the height direction of the secondary battery. As illustrated in FIG. 2, the positive electrode lead 51 includes a first part 511, a second part 512, and a turning part 513. The first part 511 and the second part 512 each extend along a horizontal plane orthogonal to the height direction Z of the secondary battery. Further, the first part 511 and the second part 512 overlap each other in the height direction Z of the secondary battery, with the sealant 61 interposed between the first part 511 and the second part 512. The turning part 513 is so curved as to couple the first part 511 and the second part 512 to each other. The first part 511 and the second part 512 are sandwiched between the battery device 40 and the recessed part 12H of the cover part 12 in the height direction Z of the secondary battery.

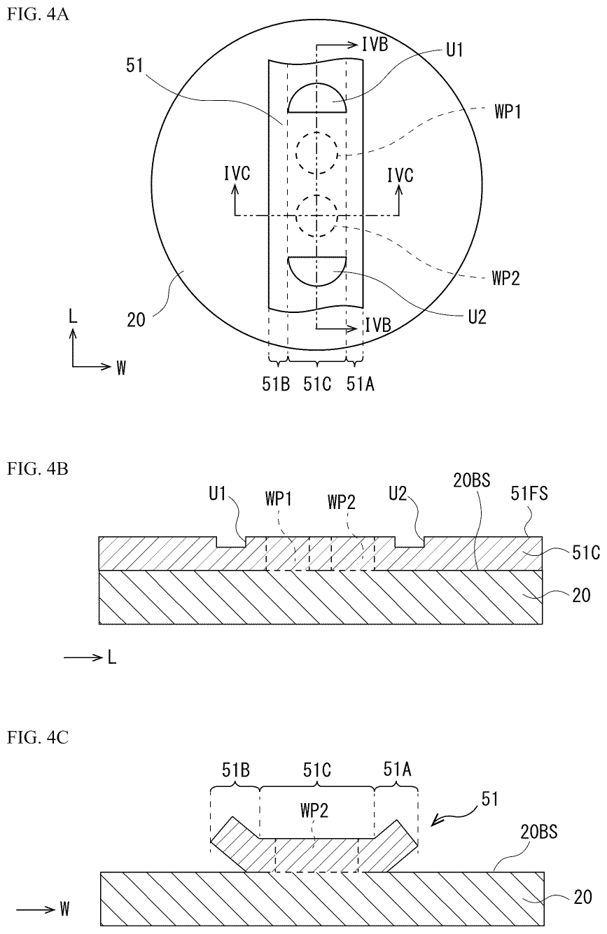

FIG. 4A is a plan diagram illustrating a configuration example of the positive electrode lead 51. Specifically, FIG. 4A schematically illustrates a state of a part at which the positive electrode lead 51 and the external terminal 20 are joined to each other, viewed from the battery device 40 inside the outer package can 10. FIG. 4B is a sectional diagram illustrating a section along a longitudinal direction of the positive electrode lead 51. Specifically, FIG. 4B illustrates a section of the positive electrode lead 51 along line IVB-IVB illustrated in FIG. 4A. FIG. 4C is a sectional diagram illustrating a section along a width direction, of the positive electrode lead 51, orthogonal to the longitudinal direction. Specifically, FIG. 4C illustrates a section of the positive electrode lead 51 along line IVC-IVC illustrated in FIG. 4A. Note that FIGS. 4A to 4C each illustrate a portion, of the positive electrode lead 51, in the vicinity of a welded part welded to a back surface 20BS of the external terminal 20. In FIGS. 4A to 4C, the longitudinal direction of the positive electrode lead 51 corresponds to an L-axis direction, and the width direction of the positive electrode lead 51 corresponds to a W-axis direction.

The positive electrode lead 51 includes a first end part 51A, a middle part 51C, and a second end part 51B in order along the width direction (i.e., the W-axis direction), of the positive electrode lead 51, orthogonal to the longitudinal direction (i.e., the L-axis direction). The middle part 51C is flat and extends along the back surface 20BS of the external terminal 20. The middle part 51C includes one or more welded parts WP welded to the back surface 20BS of the external terminal 20. FIGS. 4A and 4B each illustrate two welded parts, i.e., welded parts WP1 and WP2, as an example. In the secondary battery, as illustrated in FIG. 4C, the first end part 51A and the second end part 51B of the positive electrode lead 51 are bent in a direction away from the back surface 20BS of the external terminal 20. FIG. 4C illustrates an example case where both the first end part 51A and the second end part 51B are bent. However, according to the present disclosure, it is sufficient that at least either the first end part 51A or the second end part 51B is bent in the direction away from the back surface 20BS of the external terminal 20.

The positive electrode lead 51 may further include two depression parts, i.e., depression parts U1 and U2. The two depression parts U1 and U2 are provided on a front surface 51FS, of the middle part 51C, on an opposite side to the back surface 20BS of the external terminal 20, and are disposed side by side in the longitudinal direction (i.e., the L-axis direction) of the positive electrode lead 51. The depression parts U1 and U2 each have, for example, a substantially semicircular shape or a substantially partial annular shape in a plan view. Here, the one or more welded parts WP are positioned between the depression part U1 and the depression part U2.

Note that when the outer package can 10 of the secondary battery has the outer diameter D of, for example, 16 mm, the positive electrode lead 51 has a dimension of 4 mm or less in the width direction.

As described above, the positive electrode lead 51 includes: the middle part 51C that is flat; and the first end part 51A and the second end part 51B that are adjacent to the middle part 51C on respective sides of the middle part 51C, and are bent in the direction away from the back surface 20BS. This helps to prevent the shape of the positive electrode lead 51 from easily deformed by an external force, and thus helps to prevent, for example, when the positive electrode lead 51 is to be welded to the back surface 20BS, flatness of the middle part 51C from being easily degraded. Accordingly, the middle part 51C and the back surface 20BS are welded to each other with high welding strength. This helps to prevent the positive electrode lead 51 from being easily detached from the back surface 20BS of the external terminal 20 even when the secondary battery undergoes an external force such as a vibration or an impact.

In addition, a portion of the positive electrode lead 51 is held by the cover part 12 and the battery device 40 by extending along each of a lower surface of the cover part 12 and an upper surface of the battery device 40. This allows the positive electrode lead 51 to be fixed inside the outer package can 10. By preventing the positive electrode lead 51 from easily moving even if the secondary battery undergoes an external force such as a vibration or an impact, the positive electrode lead 51 is prevented from being easily damaged. Here, examples of damage to the positive electrode lead 51 include cracking of the positive electrode lead 51, breakage of the positive electrode lead 51, and detachment of the positive electrode lead 51 from the positive electrode 41.

More specifically, in the secondary battery according to the embodiment, a portion of the positive electrode lead 51 is sandwiched by the outer package can 10 and the battery device 40, and the positive electrode lead 51 is held by the outer package can 10 and the battery device 40 from above and below while being insulated from each of the outer package can 10 and the battery device 40. The positive electrode lead 51 is thus in a state of being not easily movable inside the outer package can 10 even if the secondary battery undergoes an external force such as a vibration or an impact. The state where the positive electrode lead 51 is not easily movable inside the outer package can 10 exactly indicates that the battery device 40 is also in the state of being not easily movable inside the outer package can 10. This also makes it possible to avoid a defect of the battery device 40, i.e., the wound electrode body, such as winding deformation, when the secondary battery undergoes, for example, a vibration or an impact.

Here, as described above, the cover part 12 includes the recessed part 12H, and a portion of the positive electrode lead 51 is sandwiched by the recessed part 12H and the battery device 40. More specifically, the portion of the positive electrode lead 51 is held by the recessed part 12H and the battery device 40 by extending along each of a bottom surface of the recessed part 12H and the top surface of the battery device 40. The recessed part 12H helps to hold the positive electrode lead 51 more easily. This helps to further prevent the positive electrode lead 51 from being easily damaged.

Further, a portion of the positive electrode lead 51 is insulated from the cover part 12 and the negative electrode 42 via each of the separator 43, the sealant 61, and the insulating films 62 and 63.

Specifically, as described above, the height of the separator 43 is greater than the height of the negative electrode 42. Accordingly, a portion of the positive electrode lead 51 is separated from the negative electrode 42 by the separator 43, and is thus insulated from the negative electrode 42 via the separator 43. One reason for this is to prevent a short circuit between the positive electrode lead 51 and the negative electrode 42.

Further, the positive electrode lead 51 is covered at a periphery thereof by the sealant 61 having an insulating property. A portion of the positive electrode lead 51 is thus insulated from each of the cover part 12 and the negative electrode 42 via the sealant 61. One reason for this is to prevent a short circuit between the positive electrode lead 51 and the cover part 12, and to also prevent a short circuit between the positive electrode lead 51 and the negative electrode 42.

Further, the insulating film 62 is disposed between the cover part 12 and the positive electrode lead 51. A portion of the positive electrode lead 51 is thus insulated from the cover part 12 via the insulating film 62. One reason for this is to prevent a short circuit between the positive electrode lead 51 and the cover part 12.

Furthermore, the insulating film 63 is disposed between the battery device 40 and the positive electrode lead 51. A portion of the positive electrode lead 51 is thus insulated from the negative electrode 42 via the insulating film 63. One reason for this is to prevent a short circuit between the positive electrode lead 51 and the negative electrode 42.

Details of a material included in the positive electrode lead 51 are similar to the details of the material included in the positive electrode current collector 41A. Note that the material included in the positive electrode lead 51 and the material included in the positive electrode current collector 41A may be the same as or different from each other.

Here, the positive electrode lead 51 is coupled to the positive electrode 41 in a region on a front side relative to the center line PC, i.e., a region on a right side relative to the center line PC in FIG. 2. In order to be coupled to the external terminal 20, the positive electrode lead 51 includes the turning part 513 in the middle of extension to the external terminal 20. The turning part 513 is present in a region on a back side relative to the center line PC, i.e., a region on a left side relative to the center line PC in FIG. 2. The positive electrode lead 51 includes the first part 511 that corresponds to a part from a location where the positive electrode lead 51 is coupled to the positive electrode 41, through the position P0 of the center, to the turning part 513. The first part 511 extends along the upper surface of the battery device 40 in a direction orthogonal to the height direction Z. In addition, the positive electrode lead 51 includes the second part 512 that corresponds to a part in the middle of extension from the turning part 513 to a location where the positive electrode lead 51 is coupled to the external terminal 20. The second part 512 so extends along the upper surface of the battery device 40 in the direction orthogonal to the height direction Z as to be laid over the first part 511. As described above, a portion of the positive electrode lead 51 is sandwiched by the cover part 12 and the battery device 40 and extends toward the external terminal 20, in both the region on the front side relative to the center line PC and the region on the back side relative to the center line PC.

Here, as is apparent from FIG. 2, “the region on the front side relative to the center line PC” is, where the battery device 40 is divided into two regions with respect to the center line PC in a direction along the outer diameter D, one, of the regions, in which the location where the positive electrode lead 51 is coupled to the positive electrode 41 is present. In FIG. 2, “the region on the front side relative to the center line PC” is the region on the right side relative to the center line PC. In contrast, as is apparent from FIG. 2, “the region on the back side relative to the center line PC” is the other region of the two regions, and is the region on the left side relative to the center line PC in FIG. 2. In other words, “the region on the back side relative to the center line PC” is, where the battery device 40 is divided into the two regions with respect to the center line PC in the direction along the outer diameter D, the other region in which the location where the positive electrode lead 51 is coupled to the positive electrode 41 is absent.

A position of coupling of the positive electrode lead 51 to the positive electrode 41 is not particularly limited, and may be chosen as desired. In particular, the positive electrode lead 51 is preferably coupled to the positive electrode 41 on an inner side of winding of the positive electrode 41 relative to the outermost wind of the positive electrode 41. One reason for this is that corrosion of the outer package can 10 caused by creeping up of the electrolytic solution is suppressed unlike when the positive electrode lead 51 is coupled to the positive electrode 41 in the outermost wind of the positive electrode 41. The “creeping up of the electrolytic solution” refers to a phenomenon in which, when the positive electrode lead 51 is disposed in proximity to an inner wall surface of the outer package can 10, the electrolytic solution in the battery device 40 creeps up along the positive electrode lead 51 to reach the inner wall surface of the outer package can 10. The electrolytic solution coming into contact with the outer package can 10 as a result of the “creeping up of the electrolytic solution” causes a phenomenon in which the outer package can 10 dissolves or changes in color.

Here, in a region between the positive electrode 41 and the external terminal 20, the positive electrode lead 51 is turned up once or more and thus lies over itself once or more. The number of times the positive electrode lead 51 is to be turned up is not particularly limited as long as it is once or more. The wording “the positive electrode lead 51 is turned up” means that the extending direction of the positive electrode lead 51 changes at an angle greater than 90° in the middle of the positive electrode lead 51. The positive electrode lead 51 preferably has, at a location where the positive electrode lead 51 is turned up, a curved shape rather than a bent shape, as with the turning part 513. Further, although FIG. 2 illustrates an example case in which the positive electrode lead 51 includes one turning part 513, the positive electrode lead 51 may include a plurality of turning parts 513.

The positive electrode lead 51 is turned up at the turning part 513 in the middle of extension from the positive electrode 41 to the external terminal 20. Specifically, as illustrated in FIG. 2, the first part 511 extends from a first position P1 to a second position P2 in a horizontal plane orthogonal to the height direction of the secondary battery. The first position P1 is other than the position P0 of the center of the outer package can 10. The second position P2 is on a side opposite to the first position P1 as viewed from the center position. The second part 512 extends from the second position P2 toward the position P0 of the center. In the positive electrode lead 51, an overlap portion of the first part 511 and the second part 512 is a surplus portion. It can thus be said that the positive electrode lead 51 has a length margin in the longitudinal direction of the positive electrode lead 51.

This provides room to change orientation of the cover part 12 relative to the container part 11 when forming the outer package can 10 by using the container part 11 and the cover part 12 in a process of manufacturing the secondary battery, as will be described later. Further, when the secondary battery undergoes an external force such as a vibration or an impact, the length margin of the positive electrode lead 51 is usable to mitigate the external force, thereby helping to prevent the positive electrode lead 51 from being easily damaged. Furthermore, the length margin of the positive electrode lead 51 is usable to change the position of coupling of the positive electrode lead 51 to the positive electrode 41 to a desired position without changing a length of the positive electrode lead 51.

In this case, the length (an entire length including the length margin) of the positive electrode lead 51 is not particularly limited, and may be chosen as desired. The length of the positive electrode lead 51 is preferably greater than or equal to half the outer diameter D of the outer package can 10, in particular. One reason for this is to ensure that the length of the positive electrode lead 51 has a length margin allowing for raising the cover part 12 relative to the container part 11, and to thereby make it easier to raise the cover part 12 relative to the container part 11.

A range of coupling of the positive electrode lead 51 to the external terminal 20 is not particularly limited. It is preferable that the range of coupling of the positive electrode lead 51 to the external terminal 20 be wide enough for the positive electrode lead 51 to be prevented from being easily detached from the external terminal 20 and be narrow enough to allow for the length margin of the positive electrode lead 51, in particular. One reason why the range of coupling of the positive electrode lead 51 to the external terminal 20 is preferably narrow enough is that a sufficiently large length margin of the positive electrode lead 51 is achievable because a portion of the positive electrode lead 51 not coupled to the external terminal 20 serves as the length margin.

Note that the positive electrode lead 51 is provided separately from the positive electrode current collector 41A. However, the positive electrode lead 51 may be physically continuous with the positive electrode current collector 41A and may thus be provided integrally with the positive electrode current collector 41A.

As illustrated in FIG. 2, the negative electrode lead 52 is contained inside the outer package can 10. The negative electrode lead 52 is electrically coupled to each of the negative electrode 42 and the outer package can 10 (the container part 11). Accordingly, the container part 11 (the bottom part M2) is electrically coupled to the negative electrode 42 via the negative electrode lead 52. Here, the secondary battery includes one negative electrode lead 52. However, the secondary battery may include two or more negative electrode leads 52.

The negative electrode lead 52 is coupled to a lower end part of the negative electrode 42, more specifically, a lower end part of the negative electrode current collector 42A. Further, the negative electrode lead 52 is coupled to a bottom surface of the container part 11. A coupling method of the negative electrode lead 52 is not particularly limited, and specifically includes any one or more of welding methods including, without limitation, the resistance welding method and the laser welding method.

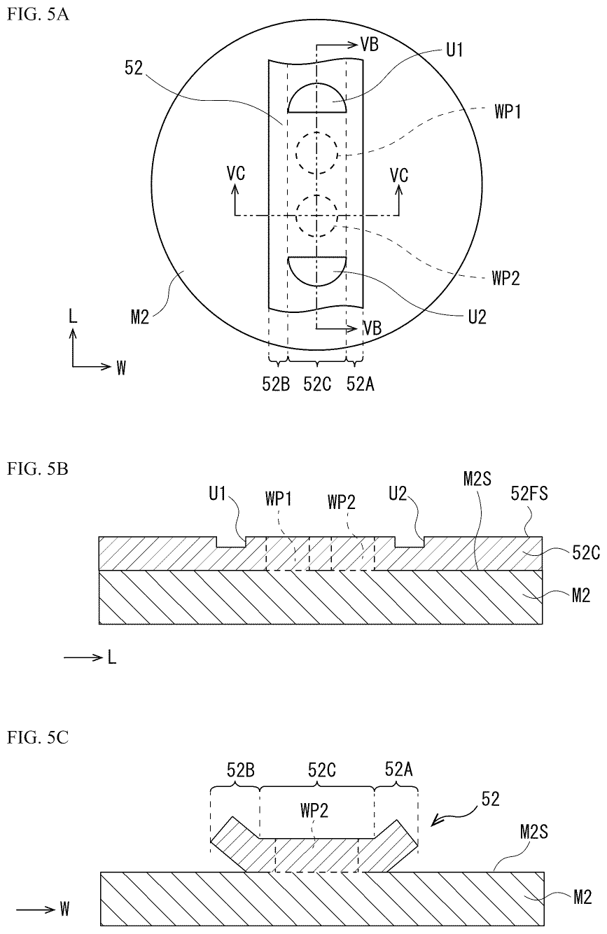

The negative electrode lead 52 may have a configuration similar to that of the positive electrode lead 51 illustrated in FIGS. 4A to 4C. FIG. 5A is a plan diagram illustrating a configuration example of the negative electrode lead 52. Specifically, FIG. 5A schematically illustrates a state of a part at which the negative electrode lead 52 and the bottom part M2 are joined to each other, viewed from the battery device 40 inside the outer package can 10. FIG. 5B is a sectional diagram illustrating a section along a longitudinal direction of the negative electrode lead 52. Specifically, FIG. 5B illustrates a section of the negative electrode lead 52 along line VB-VB illustrated in FIG. 5A. FIG. 5C is a sectional diagram illustrating a section along a width direction, of the negative electrode lead 52, orthogonal to the longitudinal direction. Specifically, FIG. 5C illustrates a section of the negative electrode lead 52 along line VC-VC illustrated in FIG. 5A. Note that FIGS. 5A to 5C each illustrate, in an enlarged manner, a portion, of the negative electrode lead 52, in the vicinity of a welded part welded to an inner surface M2S of the bottom part M2. In FIGS. 5A to 5C, the longitudinal direction of the negative electrode lead 52 corresponds to the L-axis direction, and the width direction of the negative electrode lead 52 corresponds to the W-axis direction. As illustrated in FIGS. 5A to 5C, the negative electrode lead 52 includes a first end part 52A, a middle part 52C, and a second end part 52B in order along the width direction (i.e., the W-axis direction), of the negative electrode lead 52, orthogonal to the longitudinal direction (i.e., the L-axis direction). The middle part 52C is flat and extends along the inner surface M2S of the bottom part M2. The middle part 52C includes one or more welded parts WP welded to the inner surface M2S. FIGS. 5A and 5B each illustrate two welded parts, i.e., welded parts WP1 and WP2, as an example. In the secondary battery, the first end part 52A and the second end part 52B of the negative electrode lead 52 are bent in a direction away from the inner surface M2S of the bottom part M2, as illustrated in FIG. 5C. FIG. 5C illustrates an example case where both the first end part 52A and the second end part 52B are bent. However, according to the present disclosure, it is sufficient that at least either the first end part 52A or the second end part 52B is bent in the direction away from the inner surface M2S of the bottom part M2.

The negative electrode lead 52 may further include two depression parts, i.e., depression parts U1 and U2, as with the positive electrode lead 51. Note that when the outer package can 10 of the secondary battery has the outer diameter D of, for example, 16 mm, the negative electrode lead 52 has a dimension of 4 mm or less in the width direction.

As described above, the negative electrode lead 52 also has the configuration similar to that of the positive electrode lead 51. This helps to prevent, for example, when the negative electrode lead 52 is to be welded to the inner surface M2S, flatness of the middle part 52C from being easily degraded. Accordingly, the middle part 52C and the inner surface M2S are welded to each other with high welding strength. This helps to prevent the negative electrode lead 52 from being easily detached from the inner surface M2S of the bottom part M2 even when the secondary battery undergoes an external force such as a vibration or an impact.

Details of a material included in the negative electrode lead 52 are similar to the details of the material included in the negative electrode current collector 42A. Note that the material included in the negative electrode lead 52 and the material included in the negative electrode current collector 42A may be the same as or different from each other.

A position of coupling of the negative electrode lead 52 to the negative electrode 42 is not particularly limited, and may be chosen as desired. Here, the negative electrode lead 52 is coupled to an outermost wind portion of the negative electrode 42 included in the wound electrode body.

Note that the negative electrode lead 52 is provided separately from the negative electrode current collector 42A. However, the negative electrode lead 52 may be physically continuous with the negative electrode current collector 42A and may thus be provided integrally with the negative electrode current collector 42A.

The sealant 61 is a first insulating member covering the periphery of the positive electrode lead 51, as illustrated in FIG. 2. The sealant 61 includes two insulating tapes each being attached to corresponding one of a front surface and a back surface of the positive electrode lead 51. Here, in order to allow the positive electrode lead 51 to be coupled to each of the positive electrode 41 and the external terminal 20, the sealant 61 covers the periphery of a portion in the middle of the positive electrode lead 51. Note that a structure of the sealant 61 is not limited to a tape-shaped structure, and the sealant 61 may have a tube-shaped structure, for example.

The sealant 61 includes any one or more of insulating materials including, without limitation, a polymer compound having an insulating property. Examples of the insulating materials include polyimide.

The insulating film 62 is an insulating member disposed between the cover part 12 and the battery device 40 in the height direction Z, as illustrated in FIG. 2. Here, the insulating film 62 is ring-shaped in a plan view and has an opening 62K at a location corresponding to the through hole 12K in the height direction Z.

Here, the insulating film 62 may be adhered to the cover part 12 with an adhesive layer interposed therebetween.

The insulating film 62 may include any one or more of insulating materials including, without limitation, a polymer compound having an insulating property. Examples of the insulating materials to be included in the insulating film 62 include polyimide.

The insulating film 63 is an insulating member disposed between the battery device 40 and the positive electrode lead 51, as illustrated in FIG. 2. Here, the insulating film 63 is flat plate-shaped in a plan view. The insulating film 63 is disposed to block the winding center space 40K and to cover the battery device 40 around the winding center space 40K.

Details of a material included in the insulating film 63 are similar to the details of the material included in the insulating film 62. Note that the material included in the insulating film 63 and the material included in the insulating film 62 may be the same as or different from each other.

Note that the secondary battery may further include one or more other components.

Specifically, the secondary battery includes a safety valve mechanism. The safety valve mechanism is to cut off electrical coupling between the outer package can 10 and the battery device 40 if an internal pressure of the outer package can 10 reaches a certain level or higher. Examples of a factor that causes the internal pressure of the outer package can 10 to reach the certain level or higher include occurrence of a short circuit in the secondary battery and heating of the secondary battery from outside. Although a placement location of the safety valve mechanism is not particularly limited, the safety valve mechanism is preferably placed on either the bottom part M1 or the bottom part M2, and more preferably, on the bottom part M2 to which no external terminal 20 is attached, in particular.

Further, the secondary battery may include an insulator, other than the insulating films 62 and 64, between the outer package can 10 and the battery device 40. The insulator includes any one or more of materials including, without limitation, an insulating film and an insulating sheet, and prevents a short circuit between the outer package can 10 and the battery device 40. A range of placement of the insulator is not particularly limited, and may be chosen as desired.

Note that the outer package can 10 is provided with a cleavage valve. The cleavage valve cleaves to release the internal pressure of the outer package can 10 when the internal pressure reaches a certain level or higher. A placement location of the cleavage valve is not particularly limited. However, the cleavage valve is preferably placed on either the bottom part M1 or the bottom part M2, and more preferably, on the bottom part M2, in particular, as with the placement location of the safety valve mechanism described above.

Upon charging of the secondary battery, in the battery device 40, lithium is extracted from the positive electrode 41, and the extracted lithium is inserted into the negative electrode 42 through the electrolytic solution. Upon discharging of the secondary battery, in the battery device 40, lithium is extracted from the negative electrode 42, and the extracted lithium is inserted into the positive electrode 41 through the electrolytic solution. Upon the charging and the discharging, lithium is inserted and extracted in an ionic state.

FIG. 5 illustrates a perspective configuration of the outer package can 10 to be used in the process of manufacturing the secondary battery, and corresponds to FIG. 1.

FIG. 5 illustrates a state where the cover part 12 is separate from the container part 11 before the cover part 12 is welded to the container part 11.

In the following description, where appropriate, FIGS. 1 to 4 described already will be referred to together with FIG. 5.

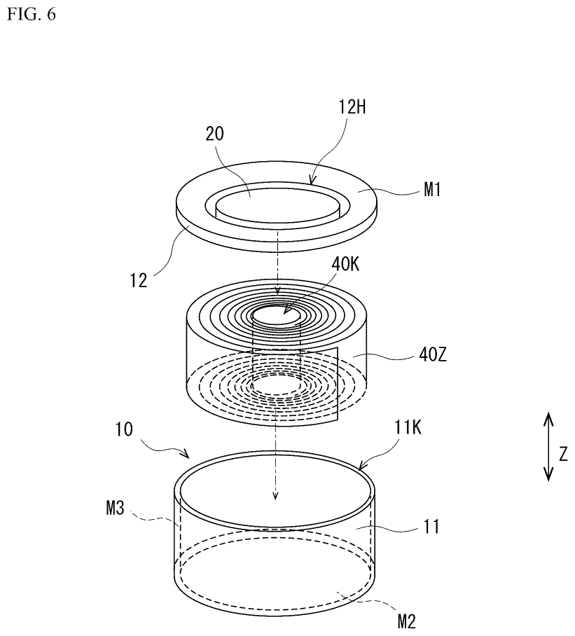

Here, as illustrated in FIG. 6, the container part 11 and the cover part 12 that are physically separate from each other are prepared to form the outer package can 10. The container part 11 is a substantially bowl-shaped member in which the bottom part M2 and the sidewall part M3 are integrated with each other, and has the opening 11K. The cover part 12 is a substantially plate-shaped member corresponding to the bottom part M1. The external terminal 20 is attached in advance to the recessed part 12H provided in the cover part 12, with the gasket 30 interposed between the external terminal 20 and the recessed part 12H.

Alternatively, the bottom part M2 and the sidewall part M3 that are physically separate from each other may be prepared and the container part 11 may be formed by welding the sidewall part M3 to the bottom part M2.

First, the positive electrode active material and other materials including, without limitation, the positive electrode binder and the positive electrode conductor are mixed with each other to thereby make a positive electrode mixture. Thereafter, the positive electrode mixture thus made is put into a solvent such as an organic solvent to thereby prepare a positive electrode mixture slurry in paste form. Thereafter, the positive electrode mixture slurry is applied on the two opposed surfaces of the positive electrode current collector 41A to thereby form the positive electrode active material layers 41B. Lastly, the positive electrode active material layers 41B are compression-molded by, for example, a roll pressing machine. In this case, the positive electrode active material layers 41B may be heated. The positive electrode active material layers 41B may be compression-molded multiple times. The positive electrode 41 is thus fabricated.

The negative electrode 42 is fabricated by a procedure similar to the fabrication procedure of the positive electrode 41. Specifically, a negative electrode mixture, which is obtained by mixing the negative electrode active material and other materials including, without limitation, the negative electrode binder and the negative electrode conductor with each other, is put into an organic solvent to thereby prepare a negative electrode mixture slurry in paste form, following which the negative electrode mixture slurry is applied on the two opposed surfaces of the negative electrode current collector 42A to thereby form the negative electrode active material layers 42B. At this time, a thickness T2 of an outer side negative electrode active material layer 42B2 covering an outer negative electrode current collector surface 42A2 is set to be greater than a thickness T1 of an inner side negative electrode active material layer 42B1 covering an inner negative electrode current collector surface 42A1. Thereafter, the negative electrode active material layers 42B are compression-molded by, for example, a roll pressing machine. The negative electrode 42 is thus fabricated.

The electrolyte salt is put into the solvent. The electrolyte salt is thereby dispersed or dissolved in the solvent. The electrolytic solution is thus prepared.

First, the positive electrode lead 51 covered at the periphery thereof by the sealant 61 is coupled to the positive electrode 41 (the positive electrode current collector 41A) by a welding method such as the resistance welding method, and the negative electrode lead 52 is coupled to the negative electrode 42 (the negative electrode current collector 42A) by a welding method such as the resistance welding method.

Thereafter, the positive electrode 41 and the negative electrode 42 are stacked on each other with the separator 43 interposed therebetween, following which the stack including the positive electrode 41, the negative electrode 42, and the separator 43 is wound to thereby fabricate a wound body 40Z, as illustrated in FIG. 6. The wound body 40Z has a configuration similar to that of the battery device 40 except that the positive electrode 41, the negative electrode 42, and the separator 43 are each unimpregnated with the electrolytic solution. Note that FIG. 6 omits the illustration of each of the positive electrode lead 51 and the negative electrode lead 52.

Thereafter, the wound body 40Z to which the positive electrode lead 51 and the negative electrode lead 52 are each coupled is placed into the container part 11 through the opening 11K. In this case, the negative electrode lead 52 is coupled to the container part 11 by a welding method such as the resistance welding method. Thereafter, the insulating film 63 is placed on the wound body 40Z.

Thereafter, the cover part 12 to which the external terminal 20 is attached in advance with the gasket 30 interposed therebetween and on which the insulating film 62 is provided in advance is prepared, following which the positive electrode lead 51 is coupled to the external terminal 20 through the through hole 12K by a welding method such as the resistance welding method.

As a result, the wound body 40Z (the positive electrode 41) contained inside the container part 11 and the external terminal 20 attached to the cover part 12 are coupled to each other via the positive electrode lead 51.

Thereafter, the electrolytic solution is injected into the container part 11 through the opening 11K. In this case, because the opening 11K is not closed by the cover part 12 as described above, the electrolytic solution is easily injectable into the container part 11 through the opening 11K even if the battery device 40 and the external terminal 20 are coupled to each other via the positive electrode lead 51. The wound body 40Z including the positive electrode 41, the negative electrode 42, and the separator 43 is thereby impregnated with the electrolytic solution. The battery device 40 that is the wound electrode body is thus fabricated.

Thereafter, the cover part 12 is brought down into close proximity to the container part 11 to thereby close the opening 11K with the cover part 12, following which the cover part 12 is welded to the container part 11 by a welding method such as the laser welding method. In this case, as illustrated in FIG. 2, a portion of the positive electrode lead 51 is caused to be sandwiched between the cover part 12 and the battery device 40, and the turning part 513 that is curved is formed on the front side relative to the location where the positive electrode lead 51 is coupled to the external terminal 20. In this manner, the outer package can 10 is formed, and the battery device 40 and other components are contained inside the outer package can 10. Assembly of the secondary battery is thus completed.

The secondary battery after being assembled is charged and discharged. Various conditions including, for example, an environment temperature, the number of times of charging and discharging (the number of cycles), and charging and discharging conditions, may be chosen as desired. As a result, a film is formed on a surface of, for example, the negative electrode 42. This brings the secondary battery into an electrochemically stable state. The secondary battery is thus completed.

As described above, in the secondary battery according to the present embodiment, the positive electrode lead 51 includes: the middle part 51C that is flat; and the first end part 51A and the second end part 51B that are adjacent to the middle part 51C on respective sides of the middle part 51C, and are bent in the direction away from the back surface 20BS. This increases the welding strength between the flat middle part 51C and the back surface 20BS of the external terminal 20. Accordingly, it is possible to, even if the battery receives an external mechanical load such as a vibration or an impact, prevent the positive electrode lead 51 from being detached from the back surface 20BS of the external terminal 20 and thus favorably maintain electrical coupling between the positive electrode lead 51 (the positive electrode 41) and the external terminal 20. Further, the positive electrode lead 51 includes the two depression parts U1 and U2 disposed side by side in the longitudinal direction of the positive electrode lead 51. This improves shape stability of the positive electrode lead 51. That is, providing the two depression parts U1 and U2 makes it possible to more stably maintain the shape of the positive electrode lead 51 that includes the flat middle part 51C and the first end part 51A and the second end part 51B that are adjacent to the middle part 51C on the respective sides of the middle part 51C. When the negative electrode lead 52 includes the two depression parts U1 and U2 disposed side by side in the longitudinal direction of the negative electrode lead 52, it is possible to improve shape stability of the negative electrode lead 52.

Note that each of the depression parts U1 and U2 is formed by, for example, pressing a jig having an abutting surface of a substantially semicircular shape or a substantially partial annular shape against the surface of the positive electrode lead 51. Here, because each of the depression parts U1 and U2 has the substantially semicircular shape or the substantially partial annular shape in a plan view, it is possible to avoid cracking of the positive electrode lead 51 when the depression parts U1 and U2 are formed. For example, when two depression parts each having a rectangular shape in a plan view are to be formed by pressing a jig having a rectangular abutting surface, the positive electrode lead 51 easily cracks. For such a reason, allowing each of the depression parts U1 and U2 to have the substantially semicircular shape or the substantially partial annular shape in a plan view improves reliability of the secondary battery according to the present embodiment.

Further, when the two depression parts each have a substantially circular shape in a plan view, due to necessity of providing the welded parts WP between the two depression parts, a spacing between the two depression parts can increase, as compared with when the depression parts U1 and U2 each having the substantially semicircular shape or the substantially partial annular shape are provided. For such a reason, allowing each of the depression parts U1 and U2 to have the substantially semicircular shape or the substantially partial annular shape in a plan view makes it easier for the secondary battery to be reduced in size.

Further, in the secondary battery according to the present embodiment, the negative electrode lead 52 includes: the middle part 52C that is flat; and the first end part 52A and the second end part 52B that are adjacent to the middle part 52C on respective sides of the middle part 52C and are bent in the direction away from the inner surface M2S. This increases the welding strength between the flat middle part 52C and the inner surface M2S of the bottom part M2. Accordingly, it is possible to, even if the secondary battery according to the present embodiment receives an external mechanical load such as a vibration or an impact, prevent the negative electrode lead 52 from being detached from the inner surface M2S of the bottom part M2, and thus favorably maintain electrical coupling between the negative electrode lead 52 (the negative electrode 42) and the outer package can 10. The secondary battery according to the embodiment thus has high reliability.

Further, in the secondary battery according to the present embodiment, the cover part 12 is provided with the recessed part 12H, and the external terminal 20 is disposed in the recessed part 12H. This makes it possible to reduce a height dimension of the secondary battery while ensuring a battery capacity.

Further, the secondary battery may have a flat and columnar shape, that is, the secondary battery may be a secondary battery that is referred to as, for example, the coin type or the button type. In such a case, the positive electrode lead 51 is prevented from being easily damaged even in a small-sized secondary battery that is highly constrained in terms of size. Accordingly, it is possible to achieve higher effects in terms of physical durability.

Further, the secondary battery may be a lithium-ion secondary battery. In such a case, it is possible to stably obtain a sufficient battery capacity through the use of insertion and extraction of lithium.

Although the present technology has been described above with reference to one or more embodiments, the configuration of the present technology is not limited to the configurations described with reference to the embodiments described herein, and is modifiable in a variety of ways.

Specifically, although the description has been given of the case where the outer package can is a welded can (a crimpless can), the outer package can is not particularly limited in configuration, and may be a crimped can which has undergone crimping processing. In the crimped can, a container part and a cover part separate from each other are crimped to each other with a gasket interposed between the container part and the cover part.

Further, although the description has been given of the case where the electrode reactant is lithium, the electrode reactant is not particularly limited. Accordingly, the electrode reactant may be another alkali metal such as sodium or potassium, or may be an alkaline earth metal such as beryllium, magnesium, or calcium, as described above. In addition, the electrode reactant may be another light metal such as aluminum.

Further, although the description has been given, regarding the secondary battery according to the embodiment above, of the case where each of the positive electrode lead 51 and the negative electrode lead 52 has the two end parts in the width direction that are both bent, it is sufficient, according to the present disclosure, that at least either the positive electrode lead or the negative electrode lead has such a configuration.

Although the secondary battery according to the embodiment described above has the positive electrode lead 51 coupled to the external terminal 20 and the negative electrode lead 52 coupled to the container part 11 of the outer package can 10, the present disclosure is not limited thereto. That is, the secondary battery of the present disclosure may have the negative electrode lead coupled to the external terminal and the positive electrode lead coupled to the outer package member.

Further, although the description has been given, regarding the secondary battery according to the embodiment above, of the example regarding the secondary battery, the battery according to the present disclosure is not limited to the secondary battery and is also applicable to a primary battery.

The effects described herein are mere examples, and effects of the present disclosure are therefore not limited to those described herein. Accordingly, the present disclosure may achieve any other effect.

The present disclosure may further encompass the following embodiments.
(1)

A battery including:
a battery device including a first electrode and a second electrode;
an outer package member containing the battery device;
an external terminal attached to the outer package member with an insulating member interposed between the external terminal and the outer package member;
a first electrode lead coupling the first electrode and an inner surface of the external terminal to each other; and
a second electrode lead coupling the second electrode and an inner surface of the outer package member to each other, in which
one or each of the first electrode lead and the second electrode lead includes a first end part, a middle part, and a second end part in order along a width direction orthogonal to a longitudinal direction of corresponding one of the first electrode lead or the second electrode lead,
the middle part is flat and is welded to the inner surface of the external terminal or the inner surface of the outer package member, and
the first end part, the second end part, or both are bent in a direction away from the inner surface of the external terminal or the inner surface of the outer package member.
(2)

The battery according to (1), in which both the first end part and the second end part of one or each of the first electrode lead and the second electrode lead are bent in the direction away from the inner surface of the external terminal or the inner surface of the outer package member.
(3)

The battery according to (1) or (2), in which
one or each of the first electrode lead and the second electrode lead includes
   two depression parts provided on a surface on an opposite side to the inner surface of the external terminal or the inner surface of the outer package member, the two depression parts being disposed side by side in the longitudinal direction, and
   one or more welded parts positioned between the two depression parts, the one or more welded parts being welded to the inner surface of the external terminal or the inner surface of the outer package member.
(4)

The battery according to any one of (1) to (3), in which
the outer package member has a substantially circular columnar outer shape having a diameter of 16 millimeters, and
the first electrode lead and the second electrode lead each have a dimension of 4 millimeters or less in the width direction.
(5)

The battery according to any one of (1) to (4), in which the first electrode includes a positive electrode, and the second electrode includes a negative electrode.
(6)

The battery according to any one of (1) to (5), in which
the outer package member includes a container and a cover part, the container having a passing-through hole through which the battery device is passable in a first direction, the container being configured to contain the battery device placed through the passing-through hole, the cover part closing the passing-through hole and having a through hole provided through the cover part in the first direction, and
the external terminal is attached to the cover part with the insulating member interposed between the external terminal and the cover part, the external terminal overlapping the through hole.
(7)

The battery according to (6), in which the cover part has an outer edge coupled to the passing-through hole of the container by welding.
(8)

The battery according to (6) or (7), in which
the cover part of the outer package member has a recessed part recessed along the first direction toward the battery device, and
the through hole is provided in the recessed part.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery comprising:
a battery device including a first electrode and a second electrode;
an outer package member containing the battery device;
an external terminal attached to the outer package member with an insulating member interposed between the external terminal and the outer package member;
a first electrode lead coupling the first electrode and an inner surface of the external terminal to each other; and
a second electrode lead coupling the second electrode and an inner surface of the outer package member to each other, wherein
one or each of the first electrode lead and the second electrode lead includes a first end part, a middle part, and a second end part in order along a width direction orthogonal to a longitudinal direction of corresponding one of the first electrode lead or the second electrode lead,
the middle part is flat and is welded to the inner surface of the external terminal or the inner surface of the outer package member, and
the first end part, the second end part, or both are bent in a direction away from the inner surface of the external terminal or the inner surface of the outer package member.

2. The battery according to claim 1, wherein both the first end part and the second end part of one or each of the first electrode lead and the second electrode lead are bent in the direction away from the inner surface of the external terminal or the inner surface of the outer package member.

3. The battery according to claim 1, wherein
one or each of the first electrode lead and the second electrode lead includes
two depression parts provided on a surface on an opposite side to the inner surface of the external terminal or the inner surface of the outer package member, the two depression parts being disposed side by side in the longitudinal direction, and
one or more welded parts positioned between the two depression parts, the one or more welded parts being welded to the inner surface of the external terminal or the inner surface of the outer package member.

4. The battery according to claim 1, wherein
the outer package member has a substantially circular columnar outer shape having a diameter of 16 millimeters, and
the first electrode lead and the second electrode lead each have a dimension of 4 millimeters or less in the width direction.

5. The battery according to claim 1, wherein the first electrode comprises a positive electrode, and the second electrode comprises a negative electrode.

6. The battery according to claim 1, wherein
the outer package member includes a container and a cover part, the container having a passing-through hole through which the battery device is passable in a first direction, the container being configured to contain the battery device placed through the passing-through hole, the cover part closing the passing-through hole and having a through hole provided through the cover part in the first direction, and
the external terminal is attached to the cover part with the insulating member interposed between the external terminal and the cover part, the external terminal overlapping the through hole.

7. The battery according to claim 6, wherein the cover part has an outer edge coupled to the passing-through hole of the container by welding.

8. The battery according to claim 6, wherein
the cover part of the outer package member has a recessed part recessed along the first direction toward the battery device, and
the through hole is provided in the recessed part.
